(19) United States
(12) Patent Application Publication
(10) Pub. No.: US 2005/0004917 A1
(43) Pub. Date: Jan. 6, 2005

(54) Apparatus, method, and program for selecting a desired object from a plurality of presented objects and a medium containing the program

(76) Inventors: Hirotaka Ueda, Nara-shi (JP); Mitsuru Minakuchi, Soraku-gun (JP); Kentaro Sakakura, Tenri-shi (JP)

Correspondence Address: BIRCH STEWART KOLASCH & BIRCH, PO BOX 747, FALLS CHURCH, VA, 22040-0747, US

(21) Appl. No.: 10/493,816

(22) PCT Filed: Sep. 9, 2002
(86) PCT No.: PCT/JP02/09176

(30) Foreign Application Priority Data
Oct. 29, 2001 (JP) 2001-331032

(51) Int. Cl. G06F 17/00

(52) U.S. Cl. 707/100

(57) ABSTRACT

In order to select a desired object, a plurality of object choices serving as candidates for a desired object are first decided (S201). Then, a plurality of object choices are ordered on a predetermined criterion that can arbitrarily be changed (S202). The object choices are displayed one by one while being switched according to the ordering, with their brightness or colors changed or using a selection mark (S203). By entering a predetermined input when the desired object is displayed as an object choice (S204-S206), the user can select the desired object (S207). Since the order of presenting object choices is decided on the criterion that can arbitrarily be changed according to their attributes or the like, the appearance of the desired object can be advanced, as compared with the case where the order is fixed.

### TECHNICAL FIELD

The present invention relates to an apparatus, a method, and a program for selecting a desired object from a plurality of objects, and a medium with the program recorded thereon. More particularly, the present invention relates to an apparatus, a method, and a program for selecting an object desired by a user from a plurality of objects displayed on a screen, and a medium with the program recorded thereon.

### BACKGROUND ART

An object as used herein includes the following. In graphics editing applications, for example, it refers to a character string formed of one or more characters and a graphic. In window systems, it refers to a window, an icon, a button, and the like. In game programs, it refers to a character operated by a player, a character to be talked to or attacked, or the like. In this manner, a target on which a user takes some action or a general symbol representing such a target is referred to as an object. Actions (operations) vary from one application to another. For example, in graphics editing applications, an action refers to an operation such as moving, deforming or rotating objects. In window systems, it refers to an operation such as moving, enlarging, reducing, opening or closing windows. In game programs, it refers to an operation on objects, such as studying, talking, attacking, opening a door, or picking up an item. In order to take an action corresponding to an object, an object to be targeted must be specified.

Recently, operations of personal computers generally use visual interfaces using many graphics called GUI (Graphical User Interface). In GUI, a desired object is specified by a pointing device such as a keyboard or a mouse to indicate a desired operation.

For example, when a particular graphic arranged on a screen is to be edited using a graphics editing program, the particular graphic is selected by operating a cursor on the screen with a pointing device to click a portion of the particular graphic or by specifying a region including a portion or the whole of the particular graphic, thereby enabling an editing operation for the selected particular graphic. In this way, an operation of selecting a graphic is required to edit the graphic using a graphics editing program.

In an environment in which a pointing device cannot be used, for example, in the case of the use of a mobile phone or the like, the operation of selecting a desired graphic as described above is extremely cumbersome.

Conventionally, in the environment in which a pointing device cannot be used, the following method has been proposed. Every time the user gives an instruction, for example, by pressing a key, the objects that may be selected are presented one by one, and the object presented when the user gives a selection instruction is interpreted as being selected by the user. However, if there are many object choices, the user has to perform key operations to change the presented object choices repeatedly until the desired object is presented. It is burdensome for the user, and the processing efficiency is not good. In this case, the processing efficiency is reduced mainly because the order of presenting objects as choices is fixed to the order of creation of objects.

Japanese Patent Laying-Open No. 4-246785 shows an apparatus for selecting a graphical component to be processed by specifying an arbitrary point in an internal region of the graphical component. In this apparatus, all the graphical components that are overlapped at the specified point are determined, and all the determined graphical components are temporarily stored in a buffer. Thereafter, the graphical components stored in the buffer are successively selected and displayed by operating a key or a mouse.

Japanese Patent Laying-Open No. 5-81393 discloses that information indicating that selection is enabled/disabled is specified beforehand for each type of graphics, and based on the specified information, an operation of selecting a graphic using a mouse is carried out.

Japanese Patent Laying-Open No. 5-314232 shows an apparatus for selecting a graphic positioned closest to a point specified on a screen by a pointing device.

Japanese Patent Laying-Open No. 6-28441 shows an apparatus for selecting a desired graphic by maintaining a plurality of graphics with identification names in a hierarchy and then tracing the hierarchy.

Japanese Patent Laying-Open No. 6-149963 shows an apparatus for selecting a graphical object with an icon rather than with a name in creating a graphic.

Japanese Patent Laying-Open No. 6-162158 shows an apparatus in which when an area including a graphic to be edited is specified on a screen displaying a plurality of graphics, graphical objects within the specified area are successively switched and displayed.

Japanese Patent Laying-Open No. 4-320579 shows an apparatus that displays graphic choices based on a static priority when a selected point where a plurality of graphics overlap is specified by a pointing device.

Any technologies disclosed in the above publications are poor in efficiency of selection since the ordering of presenting graphics as choices of selection is static.

### DISCLOSURE OF THE INVENTION

An object of the present invention is to provide an apparatus, a method, and a program allowing for efficient selection of a desired object, as well as a medium with the program recorded thereon.

An object selecting apparatus in accordance with an aspect of the present invention includes: a presentation region; an input unit externally operated; an ordering unit ordering a plurality of object choices that are presented in the presentation region to be choices of selection, on a predetermined criterion that can arbitrarily be changed; an object choice presenting unit presenting the plurality of object choices in a specific manner in the presentation region while switching the plurality of object choices in order as arranged by the ordering unit; and a selecting unit selecting the object choice presented by the object choice presenting unit as a desired object according to a predetermined input from the input unit.

An object selecting method in accordance with another aspect of the present invention includes: an ordering step of ordering a plurality of object choices that are presented in a presentation region prepared beforehand to be choices of selection, on a predetermined criterion that can arbitrarily be changed; an object choice presenting step of presenting the plurality of object choices in the presentation region in a specific manner while switching the plurality of object choices in order as arranged at the ordering step; and a selection step of selecting the object choice presented at the object choice presenting step as a desired object according to a predetermined input from an externally operated input unit prepared beforehand.

A machine-readable recording medium in accordance with still another aspect of the present invention has an object selecting program recorded thereon for causing a computer to carry out the object selecting method as described above.

An object selecting program in accordance with a further aspect of the present invention causes a computer to carry out the object selecting method as described above.

In accordance with each aspect of the present invention as described above, a plurality of object choices are ordered on a predetermined criterion that can arbitrarily be changed, and are presented one by one in a specific manner (with their brightness or colors changed or by displaying a selection mark). The user can select a desired object by entering a predetermined input when the desired object is presented as an object choice. In this way, since the order of presenting object choices is arranged on a predetermined criterion that can arbitrarily be changed, the appearance of the desired object as the object choice can be advanced, as compared with the case where the order is fixed, thereby improving operation efficiency of object selection.

### BRIEF DESCRIPTION OF THE DRAWINGS

FIG. 1 is a block configuration diagram of an object selecting apparatus in accordance with an embodiment of the present invention.

FIG. 2 is a flowchart of a process of selecting an object using the object selecting apparatus in FIG. 1.

FIG. 3 is an external view of a mobile phone provided with the object selecting apparatus in FIG. 1.

FIG. 4 is an internal block diagram of the mobile phone in FIG. 3.

FIG. 5 illustrates an exemplary storage content of an object storing unit in FIG. 1.

FIGS. 6A and 6B show exemplary displays of an edit menu screen.

FIG. 7 illustrates an exemplary display on the screen in a graphics-editing program using an object selecting method in accordance with the embodiment.

FIG. 8 illustrates a specific procedure for selecting an object.

FIGS. 9A-9H illustrate a specific procedure for selecting an object.

FIGS. 10A-10H illustrate a specific procedure for selecting an object.

FIG. 11 shows an exemplary table of evaluation values that is referred to for ordering.

FIG. 12 shows another example of a table of evaluation values that is referred to for ordering.

FIG. 13 is a flowchart of a selecting process including ordering using evaluation values.

FIG. 14 shows an exemplary table that is referred to for ordering according to grouping.

### BEST MODES FOR CARRYING OUT THE INVENTION

In the following, the embodiments of the present invention will be described in detail with reference to the figures. An object selecting apparatus as shown here is assumed to be mounted on a mobile phone, although the present invention is not limited thereto. For example, it may be mounted on a PDA (Personal Digital Assistant), a personal computer, or the like. When it is mounted on such equipment, object selection can be performed efficiently even when a pointing device cannot be used in such equipment. Furthermore, although the objects are assumed to be character strings or graphics for graphics editing applications, the present invention is not limited thereto and may include a variety of objects as described above. Although as a kind of operation, an operation for editing a character string or a graphic is described here by way of example, the present invention is not limited thereto and may include different kinds of operations.

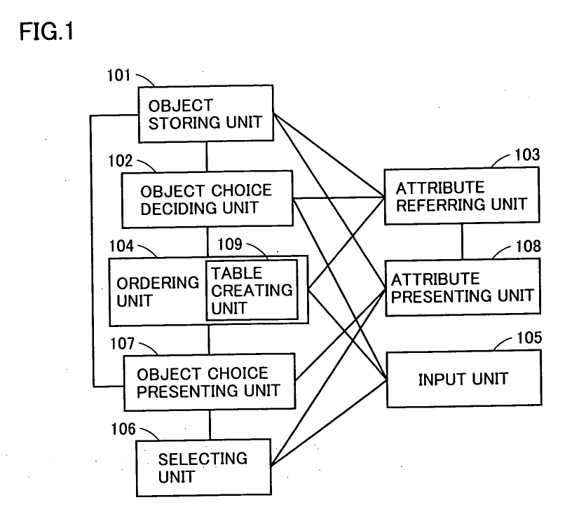

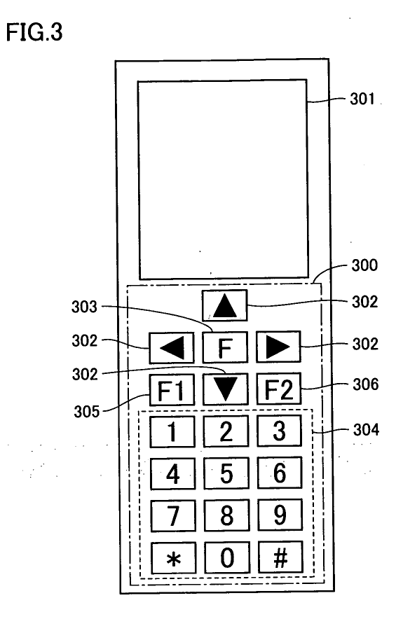

In FIG. 1, the object selecting apparatus includes an object storing unit 101, an object choice deciding unit 102, an attribute referring unit 103, an ordering unit 104 having a table creating unit 109, an input unit 105, a selecting unit 106, an object choice presenting unit 107, and an attribute presenting unit 108. In FIG. 3, the mobile phone includes a key input unit 300 and a screen 301. Key input unit 300 includes, for external operations, a direction key 302 pressed in order to indicate each direction of up, down, left, and right within screen 301, a decide key 303 operated to decide an immediate preceding operation, a dial key 304 including numeric keypads of 0, 1, 2, . . . , 9, a * key, and a # key, a text selecting function key 305, and a graphic selecting function key 306. Text selecting function key 305 is pressed to select an object corresponding to a text (character string). Graphic selecting function key 306 is pressed to select an object corresponding to a graphic.

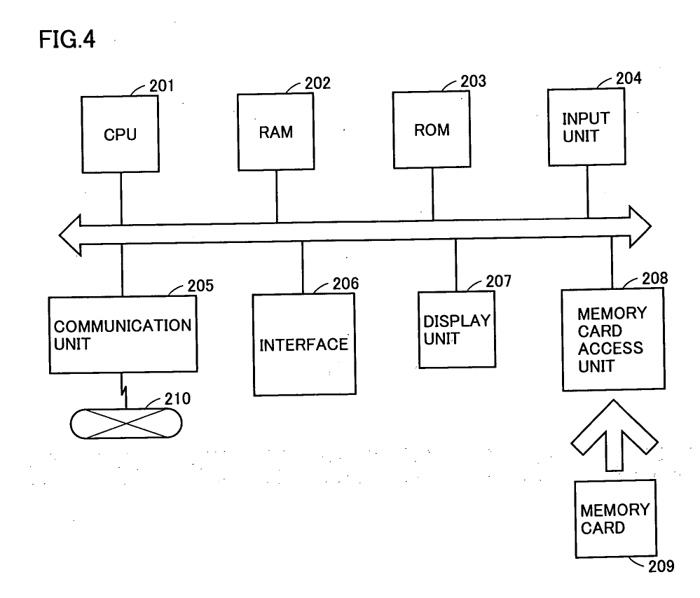

In FIG. 4, the mobile phone includes a CPU (the abbreviation for Central Processing Unit) 201 for centrally managing and controlling the mobile phone, an RAM (Random Access Memory) 202, an ROM (Read Only Memory) 203, an input unit 204 including keys 302-306 shown in FIG. 3 and corresponding to input unit 105, a communication unit 205 for connecting an external communication network 210 with the mobile phone to allow for communications, an interface 206, a display unit 207 including screen 301, and a memory card access unit 208. Memory card access unit 208 is detachably loaded with a memory card 209 to read data stored in the loaded memory card 209 and to write prescribed data into the loaded memory card 209. Interface 206 functions to connect an external device (such as a computer or a PDA) with the mobile phone to allow for mutual-data communications. A variety of wireless or wired communication networks including the Internet may apply to communication network 210.

Referring to FIG. 1, object storing unit 101 is provided in RAM 202 to store information about a plurality of objects to be displayed on screen 301. Object choice deciding unit 102 decides a plurality of object choices from a plurality of objects displayed on screen 301. Object choices are candidates of objects that are presented in order to select a desired object. Attribute referring unit 103 obtains an attribute of an object. Ordering unit 104 decides the order of presenting a plurality of object choices decided by object choice deciding unit 102. Selecting unit 106 selects a desired object according to an input content through an operation of input unit 105 by the user. An object desired and selected by the user is called a selected object. Object choice presenting unit 107 displays object choices in the order decided by ordering unit 104, on screen 301 through display unit 207. Attribute presenting unit 108 displays an attribute of an object choice or a selected object at display unit 207. Table creating unit 109 creates a variety of tables that are referred to for ordering, as will be described later.

Object storing unit 101 in FIG. 5 stores a record Ri (i=1, 2, 3, . . . , n) for each of a plurality of objects displayed on screen 301. Record Ri includes object data DA and attribute information AT. Object data DA is data used to draw a corresponding object. Object data DA includes data indicating a type (a kind such as a circle, a character string, a rectangle, a line) of a corresponding object. Attribute information AT includes data D1-D10 for a corresponding object. Data D1 is ID (Identification) data for uniquely identifying a corresponding object. Position data D2 indicates a position in screen 301 where a corresponding object is displayed. Data D3 indicates a value representing a specific size of a corresponding object.

Even if an object has corresponding data D3 having a large value, that is, the object is actually large, it may be obstructed by an object in front of it or displayed in a smaller size in perspective when displayed in the back of screen 301. Data D4 indicates a value representing an area of a corresponding object as displayed.

Data D5 indicates a color of a corresponding object as displayed on screen 301. Data D6 indicates a line width of a corresponding object as displayed on screen 301. Data D7 indicates a value representing an ordinal position of a corresponding object in the overlap of a plurality of objects. Data D8 indicates a date when a corresponding object is created. Data D9 indicates a recent date when a corresponding object is accessed (including selection). Therefore, data D9 is updated every time the corresponding object is accessed. Data D10 indicates a date when object data DA or attribute information AT of a corresponding object is updated. Here, although object data DA is data used to draw an object, the present invention is not be limited thereto and includes any data as long as it points to data for object drawing. For example, a pointer for pointing to data used to draw an object stored in RAM 202 in advance may be stored for each of a plurality of objects.

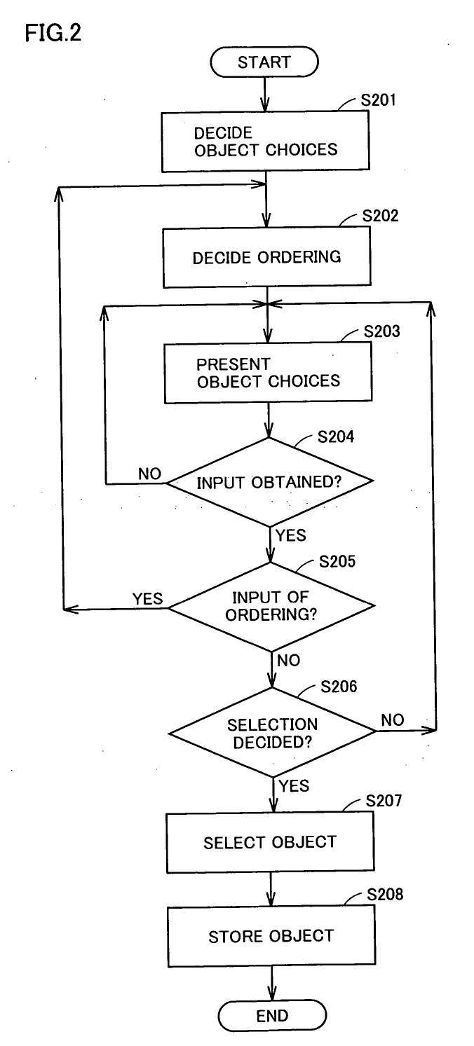

Referring now to the flowchart in FIG. 2, a process for the user to select a desired object will be described.

First, object choice deciding unit 102 decides a plurality of object choices from objects having corresponding information stored in object storing unit 101, that is, from a plurality of objects displayed on screen 301, based on attribute information AT read and obtained from storing unit 101 by attribute referring unit 103 or use's input information from input unit 105 (step S (step S will be simply abbreviated as S hereinafter) 201). Then, ordering deciding unit 104 decides the order in which a plurality of object choices are presented (displayed) on screen 301, based on attribute information obtained by attribute referring unit 103 or the user's input information from input unit 105 (S202).

Thereafter, object choice presenting unit 107 presents the object choices one by one on screen 301 according to the order decided by ordering unit 104 (S203). Here, the presented object choices are highlighted with their brightness or colors changed or with a selection mark as described later.

When an object choice is highlighted and presented in a certain order on screen 301 by object choice presenting unit 107 in this manner, the user confirms the presented object choice. After the highlighted object choice is presented, the process waits until some input from the user through input unit 105. If there is no input after a predetermined time period (NO at S204), the process will return to S203, and object choice presenting unit 107 presents an object choice corresponding to the next ordinal position in a highlighted manner.

On the other hand, if there is some input within the predetermined time period (YES at S204), the content of the input is determined. As a result of determination, if it is determined that the input content indicates ordering based on a new criterion (YES at S205), ordering unit 104 reorders a plurality of object choices decided at S201, according to the input content at S204 (S202). Thereafter, the process will proceed in the similar manner as described above.

As a result of determination, if it is determined that the input content does not indicate ordering based on a new criterion (NO at S205), it is determined whether the input content indicates that the highlighted and presented object choice in a certain ordinal position should be selected and decided as a desired object choice, or it indicates that the object choice corresponding to the next ordinal position should be presented (S206).

The input content is, for example, pressing of decide button 303. When it is determined that it indicates that the object choice is selected and decided (YES at S206), selecting unit 106 selects the object choice highlighted and presented here (S207), and stores it as a selected object in a predetermined region of RAM 202 (S208). As a result of determination, when it is determined that presentation of the object choice corresponding to the next ordinal position is indicated (NO at S206), the process returns to S203, where object choice presenting unit 107 highlights and presents the object choice corresponding to the next ordinal position. Thereafter, the process will proceed in the similar manner as described above.

Here, when the object choice is selected and the selected object is decided at S207, attribute information AT in object storing unit 101 for the selected object may be referenced by attribute referring unit 103, and attribute presenting unit 108 may display on screen 301 the attribute based on a reference result in association with the selected object. For example, 108 may display the object name of the selected object on screen 301. Alternatively, a sound assigned beforehand for each object may be produced when the object is selected. Thus, the selected object can be clearly determined by the sound even when a plurality of objects are displayed in a overlapping manner to make it difficult to see which object is selected. Alternatively, a load may be applied, according to the size of the object, to the operational portion (such as keys or buttons) of key input unit 300 used for selection and decision by the user. Thus, the user can know the approximate size of the selected object by feeling resistance caused by the load.

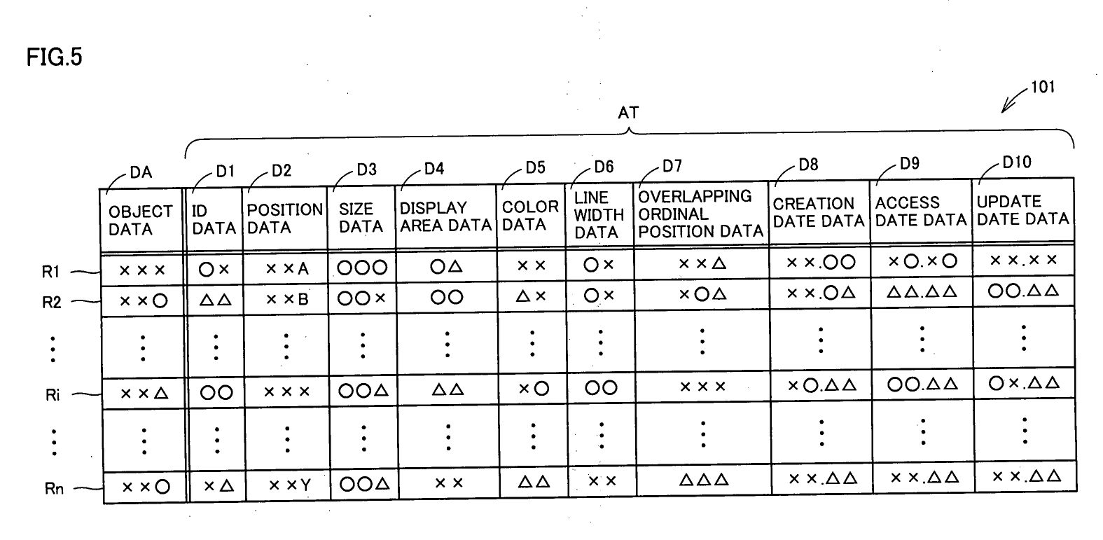

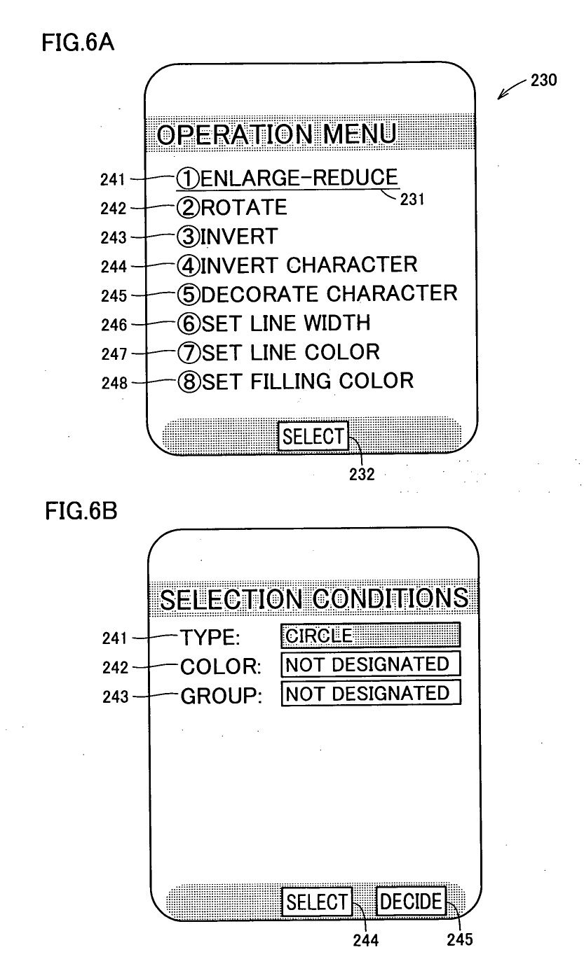

The process of deciding object choices (S201) in FIG. 2 is carried out, for example, using an edit menu screen in FIGS. 6A and 6B displayed on screen 301. An operation menu 230 is displayed on the screen of FIG. 6A. Operation menu 230 shows a select button 232 and names of different kinds of operations that can be performed on objects. When the user looks at operation menu 230 in FIG. 6A and presses button 232 (indicates) to designate the name of the desired operation through input unit 105, the desired operation as designated is selected. The selected operation name is highlighted, for example, with an underline 231. The selected desired operation limits and specifies those objects on which that operation can be performed, that is, the object choices, as follows. When the operation of “enlarge-reduce” 241 in operation menu 230 is selected, the object choices are limited to graphics or texts. Similarly, when the operations “rotate” 242, “invert” 243, “set line width” 246, “set line color” 247, and “set filling color” 248 for objects are selected, the object choices are limited to graphics. Similarly, the operations “edit character” 244 and “decorate character” 245 are selected, the object choices are limited to texts (character strings).

The screen of FIG. 6B is displayed as an interface for selecting a desired object among the object choices specified using the screen of FIG. 6A. FIG. 6B is a screen used to input the conditions of selecting an object. The user can operate input unit 105 to designate three items of “type” 241 of the object, “color” 242 of the object, and “group” of the object, as the conditions for selecting an object. In the screen of FIG. 6B, the user can designate a kind of object choice with “type” 241. In this designation, a list box (not shown) is displayed, which consists of the kinds of objects including, for example, text, circle, rectangle, straight line, polygon, free curve, and the like. The user selects a desired kind from the list box through input unit 105, so that the selected kind is designated as “type” 241. As the content of the list box varies depending on the kind of object currently displayed on screen 301, the kind not displayed on screen 301 is not presented in this list box. A plurality of different kinds can be selected using this list box. For example, it is also possible to select and designate circle and rectangle.

When “color” 242 is designated, a list of kinds of colors currently displayed on screen 301 is also displayed in a list box. Thus, when the user selects a desired kind of color from the list box, an object having color data D5 indicative of the selected kind of color is designated as an object choice. It is noted that if there are so many kinds of colors presented on screen 301 that they outnumber the kinds that can be displayed in the list box, a list of kinds of colors is displayed in the list box, for example, in such a manner that a single blue color is representative of blue-based colors.

“Group” 243 allows the user to designate a group, which can be defined arbitrarily by the user. The user can register a plurality of objects as a group. The objects frequently selected by the user are registered as a group in advance, and that group can be designated as “group” 243, so that the operation of selecting an object can be performed efficiently.

The content of the list box corresponding to “type” 241 is displayed as follows: As attribute referring unit 103 applies to attribute presenting unit 108 the content that is decided based on object data DA for each object in object storing unit 101, attribute presenting unit 108 displays the list box based on the applied content. The content of the list box corresponding to “color” 242 is displayed as follows. As attribute referring unit 103 applies to attribute presenting unit 108 the content that is decided based on color data D5 for each object in object storing unit 101, attribute presenting unit 108 displays the list box based on the applied content. The selection in the list box is carried out by operating (indicating) button 244 on the screen of FIG. 6B, and the decision for designating a selection is carried out by operating (indicating) button 245. FIG. 6B shows that “circle” is designated as “type” 241 and nothing is designated for “color” 242 and “group” 243.

The process of deciding object choices (S201) may be performed as follows. When object choice deciding unit 102 detects through input unit 105 that the user has pressed text selecting function key 305, only the objects corresponding to texts (character strings) are decided as the object choices, among a plurality of objects displayed on screen 301. When it is detected that graphic selecting function key 306 is pressed, only the objects corresponding to graphics are decided as the object choices, among a plurality of objects displayed on screen 301.

Although the process at S201 is executed here, the process at S201 may be omitted. In such a case, the object choices will be all the objects displayed on screen 301.

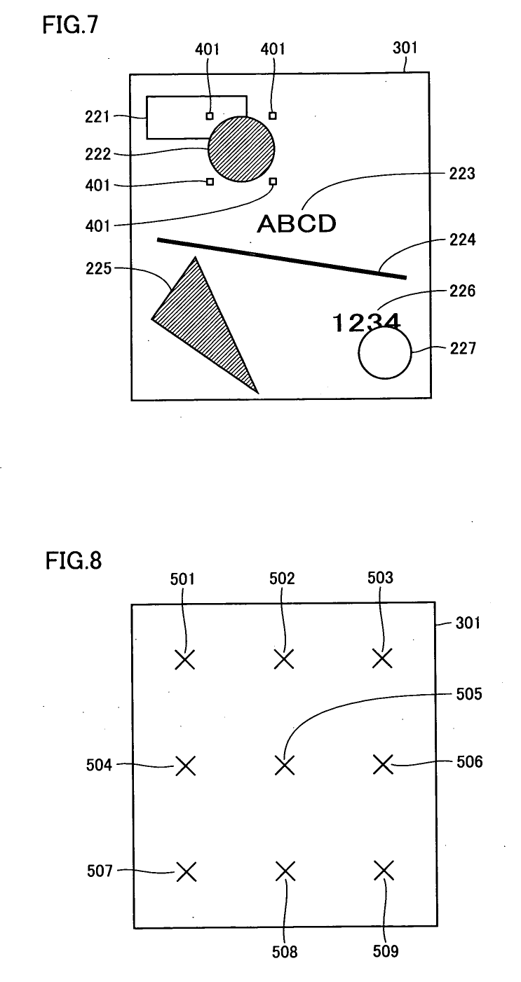

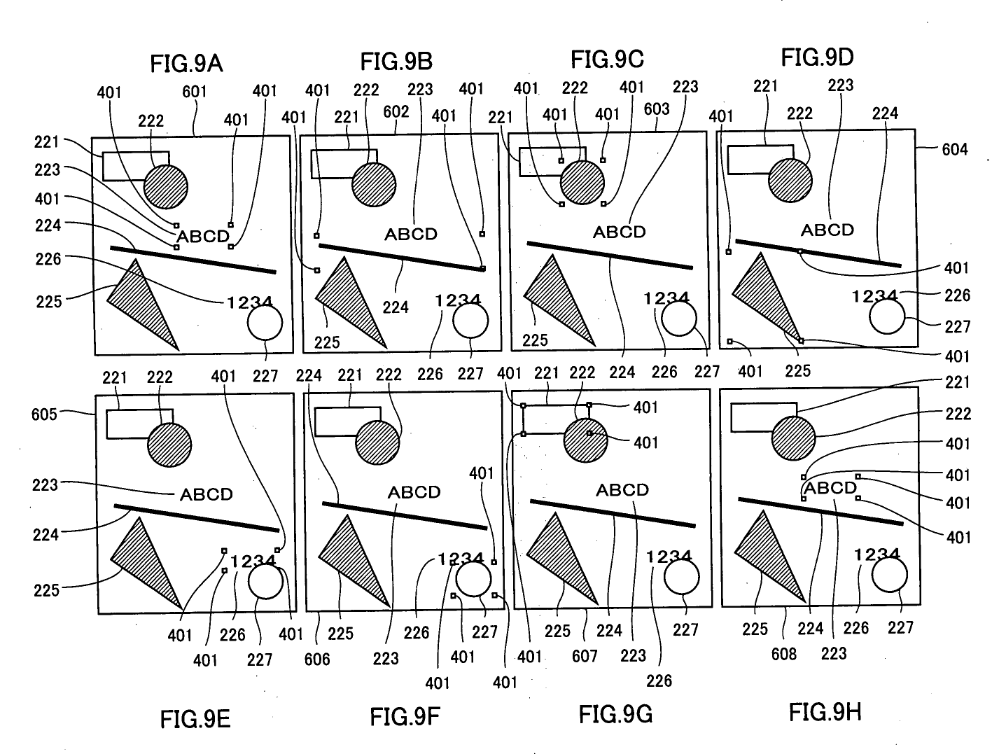

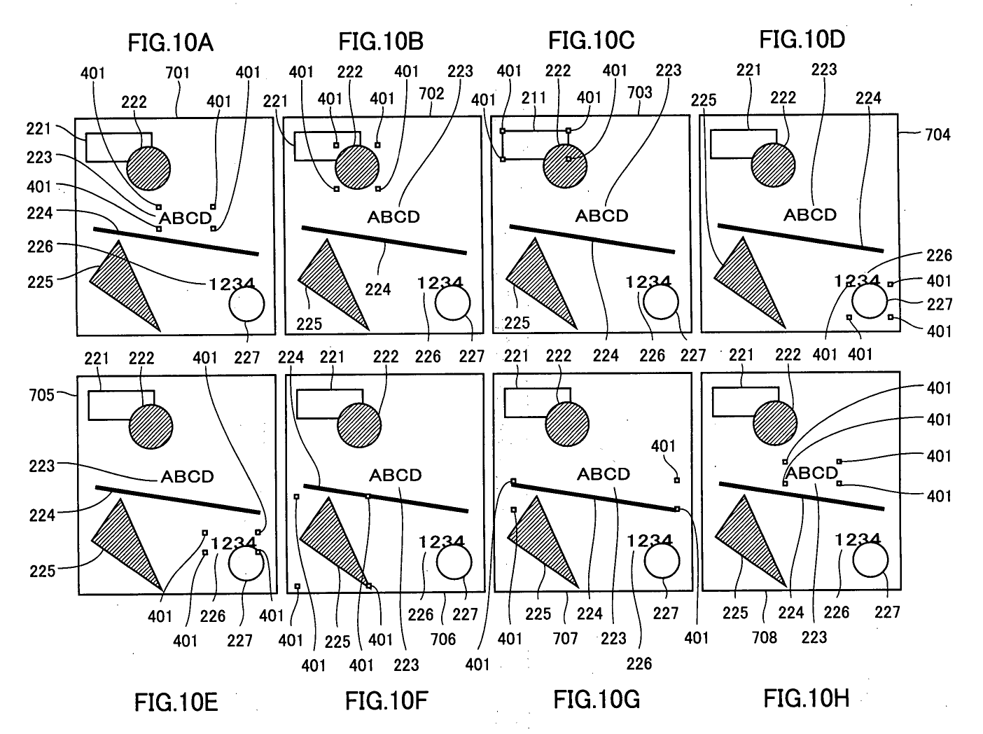

FIGS. 7 and 8 show exemplary displays on screen 301 according to a graphics editing program using an object selecting method in accordance with the present embodiment. FIGS. 9A-9H and FIGS. 10A-10H show exemplary displays on screen 301. FIGS. 9A-9H and FIGS. 10A-10H show screens 601-608 and screens 701-708 as screen 301 for the purpose of illustration.

In FIG. 7, objects 221-227 are displayed as object choices on screen 301. Object 221 represents a rectangle. Objects 222 and 227 represent circles, respectively. Objects 223 and 226 represent character strings “ABCD” and “1234”, respectively. Object 224 represents a straight line. For objects 221-227, corresponding records Ri are registered in object storing unit 101 in advance. Of objects 221-227, objects 223 and 226 as character strings permit operations of moving, enlarging and reducing, and the other objects permit operations of moving, enlarging, reducing, and rotating. On screen 301 of FIG. 7, four selection marks 401 are shown along with objects 221-227. Four selection marks 401 are displayed by object choice presenting unit 107. An object surrounded by four selection marks 401 is highlighted, which shows that the object is presented for selection. On screen 301 of FIG. 7, object 222 is highlighted and presented for selection.

Referring to screen 301 of FIG. 7, a variety of methods for selecting an object according to the flowchart in FIG. 2 will be described hereinafter.

One of the selecting methods will be described. Here, it is assumed that keys “1”-“9” in dial keys 304 are associated with points 501-509 displayed on screen 301 shown in FIG. 8, respectively. Each of points 501-509 is herein called a reference point. By pressing any one of keys “1”-“9”, the user can select an object displayed at a position closest to the reference point associated with the key pressed by the user. Here, various methods can be assumed to measure a distance. For example, the distance between the center of the rectangle circumscribing the object and the reference point associated with the pressed key may be measured. Alternatively, the distance between the barycenter of the object or the upper left vertex of the circumscribing rectangle and the reference point associated with the pressed key may be measured.

For example, when key “5” is pressed at S201 in FIG. 2, object 223, object 224, object 222, object 225, object 226, object 227, and object 221 are ordered in order of closeness to reference point 505 in FIG. 8 (S202). Object 223 is surrounded with four selection marks 401 and displayed as shown in screen 601 of FIG. 9A by object choice presenting unit 107 (S203). Thereafter, when a loop process of S203 and S204 is repeated without any input or when a loop process of S203-S206 is repeated by repeatedly pressing key “5”, screens 602-608 of FIGS. 9B-9H are displayed in order. Therefore, object choices 221-227 displayed on screen 301 are highlighted each with selection marks 401 according to a predetermined order.

Here, it is assumed that the operation for switching and highlighting the object choices is successively pressing key “5”, although the present invention is not limited thereto. For example, it may be successively pressing one or more keys other than key “5”. Alternatively, it may be an operation of moving a not-shown slider to a certain direction, an operation of rotating a not-shown wheel to a certain direction, an operation of rotating a not-shown ball to an arbitrary direction, an operation of tilting a not-shown joystick to an arbitrary direction, or an operation of tilting the apparatus itself

When an object choice is highlighted, the user presses key 303 of input unit 105 indicating object selection and decision (YES at S206). Then, the object surrounded by selection marks 401 when the user presses the key is selected (S207), and the object is stored in a predetermined storage region of RAM 202 (S208).

When the user carries out the other kind of input, rather than pressing key 303, the object choices are newly ordered based on another criterion according to the input content (S202). Thereafter, the process will proceed in the similar manner as described above according to the new ordering.

Although pressing of key “5”has been described herein, selection can be performed similarly by pressing another key of keys “1” to “9”.

Furthermore, the following selecting method may be employed. In the case where the selected object as selected at S207 and stored is included in a plurality of object choices, the object choices other than the stored, selected object may be ordered and then presented in the order as arranged.

Therefore, for example, when a process of selecting all of five object choices is performed, the process is terminated after the selected objects in the first and second places as arranged according to the flowchart in FIG. 2 are decided and stored. When the process is thereafter resumed, the other three choices are ordered and selected while being presented. Therefore, the object that has been already selected is not presented again, so that the user can select an object efficiently.

In addition, the selecting method may be as follows. For example, a plurality of object choices decided at S201 may also be ordered according to creation date data D8 in the corresponding attribute information AT. For example when “0” key of dial key 304 is pressed with none of objects being selected, ordering unit 104 orders the objects in ascending (descending) order of creation date based on data D8 read from object storing unit 101 by attribute referring unit 103 (S202). Based on such ordering, the objects are presented one by one using selection marks 401 by object choice presenting unit 107 (S203). Thereafter, the process will proceed in the similar manner as described above.

Although it has been described-here that the ordering by pressing key “0” is according to creation date data D8, the present invention is not limited thereto. For example, it may be the order of overlapping according to data D7 indicating overlapping ordinal positions of object choices, the order of size according to size data D3, or the order according to data D4 of display area.

In this way, a plurality of objects are ordered for presentation according to their attribute information AT. The appearance of an object desired by the user can be advanced by presenting the objects, for example based on data D2, in order from the left of screen 301, in order from the top, or in order of closeness from the cursor position or the currently selected object, thereby reducing the operation time. For example, when all the objects need to be once operated, a path by which the total distance traveled between objects may be minimized is calculated, and the objects are switched for presentation in the order according to the path. This decreases the movement amount of the line of sight.

When ordering is based on data D7, a plurality of overlapping objects are presented from the bottom or, to the contrary, from the top of the overlap. When ordering is based on data D3, a plurality of objects are presented simply in order of size or presented in order of closeness to the size indicated by the user. Therefore, the appearance of an object desired by the user can be advanced.

The ordering based on data D4 has the following advantage. When an object, which is actually large, is obstructed by an object in front of it or is displayed in a smaller size in perspective on screen 301, the area indicated by data D4 may sometimes be smaller. Since the ordinal position can be visually recognized more easily in this case than in the method using the actual object size, in some applications, effective ordering can be performed.

Ordering may also be performed based on a combination of a variety of data of attribute information AT as described above. For example, when a plurality of devices (a wheel, a slider bar, and the like), though not shown, are used in place of key input unit 300, the objects can be switched for presentation in order of overlapping with a wheel, in order from the left with a horizontal slider bar, and in order from above with a vertical slider bar.

The process of deciding object choices at S201 may be as follows. For example, assume that the user selects “rotate” 242 from operation menu 230 of FIG. 6A to perform an object-rotating operation. In this case, since the target object to be rotated is restricted to a rotatable object, objects 223 and 226 as character strings are not to be selected on screen 301 of FIG. 7. In this manner, the number of times that buttons or keys are operated at steps S204 and S205 until the user selects a desired object can be reduced.

The process of deciding object choices may be as follows. For example, the user can narrow down object choices based on attribute information AT. For example, when “circle” is specified in “type” 241 in FIG. 6B to limit the choices only to the objects corresponding to circle, the number of object choices on screen 301 of FIG. 7 is only two, thereby facilitating the subsequent selection. Similarly, the object choices are limited by the data showing a plurality of attributes including “color” 242 (color data D5) and “type” 241, making selection more efficient.

The user may use a combination of the selection methods as described above. For example, when object 226 in FIG. 7 is to be selected, “9” key of dial key 304 is first pressed. Then, object 227 displayed at a position closest to reference point 509 corresponding to “9” key is presented in the first place (S203). When object 227 is presented, the key indicating the upward direction of direction key 302 is pressed (YES at S204 and YES at S205), causing ordering according to the upward direction key to be newly performed (S202). Therefore, the object presented in the first place according to this ordering, that is, object 226 is highlighted with selection marks 401. As a result, the user can quickly select the desired object 226.

Still another method of selecting an object will be described. For example, it is possible to present object choices in decreasing order of possibility of being selected next time, based on a history of selected objects. A probability of being a selected object is found based on information of a history of being a selected object for each of a plurality of object choices. Then, a plurality of object choices may be ordered in decreasing order of probability as found and may be presented according to the ordering.

Now, it is assumed that five objects A-E are displayed on screen 301 and they are all object choices. It is assumed that objects A-E have been decided as selected objects in the past, in order of A, B, A, C, B, D, E, C, B, D, A, C. Here, a method for estimating an object that may be a selected object next time will be considered.

For each of these five objects, the number of times each of the other four objects is decided as the next selected object is counted. The result is shown in the table in FIG. 11. The table in FIG. 11 is stored, for example, in RAM 202 and referred to by ordering unit 104 for ordering. The table in FIG. 11 has such records, for example for object A, in that immediately after object A is selected, object B is decided as a selected object once, object C is decided as a selected object twice, and neither objects D nor E have been decided as selected objects. For the other objects, similar records are kept.

As shown in FIG. 11, by recording information indicating a history of object selections, when a certain object is selected, the object that is likely to be selected next time can be specified based on the recorded information. When object A is selected, the objects likely to be selected next time are objects C, B, D (E) in order, according to the table of FIG. 11. In this way, based on the history information of object selection in the table of FIG. 11, the object that has a high tendency (possibility) to be selected immediately after may be found, and the object choices may be presented in descending order of tendency (possibility). With more information recorded in the table of FIG. 11, the accuracy of specifying an object having a high tendency (possibility) to be selected next time is improved.

While in this example only detected is the tendency (possibility) of selection of an object immediately after one object is selected, the following method may also be employed. For example, the table of FIG. 11 is created for each kind of operation as designated in FIG. 6A. Then, the tendency (possibility) of selection may be found based on the content of the table corresponding to the kind of selected operation, and the object choices may be ordered in order of tendency (possibility) as found.

For a more efficient selection operation, history information of selection based on attribute information AT is recorded beforehand for an object choice. Then, an attribute common to the selected objects may be detected based on the recorded information, and an object that has a high possibility (tendency) of being selected next time may be specified and advanced in presenting order. In this case, it is possible to decide the order dynamically according to the history of selection made by the user. Therefore, it is possible to advance the appearance of an object that is likely to be selected in view of characteristics of user's operation.

It is noted that the table of FIG. 11 is created by table creating unit 109 and stored in RAM 202. The content of the table is continuously updated by table creating unit 109.

Furthermore, the object selection method according to the following ordering may be employed. In a graphical operation or the like, the tendency in which an object is selected successively is considered more important than a tendency in which an object is selected immediately after. In such a case, an evaluation value should be set not only for the object selected immediately after a certain object but also for the objects selected before and after a certain object. For example, an evaluation value of an object that may be selected following a certain object is calculated according the following rules (1)-(5). These rules give a point to the object selected before or after a certain object. More specifically, an object selected after is given more points than an object selected before.

Rule (1): an object selected two objects before a certain object is given one point.

Rule (2): an object one object before a certain object is given two points.

Rule (3): an object one object after a certain object is given three points.

Rule (4): an object two objects after a certain object is given two points.

Rule (5): an object three objects after a certain object is given one point.

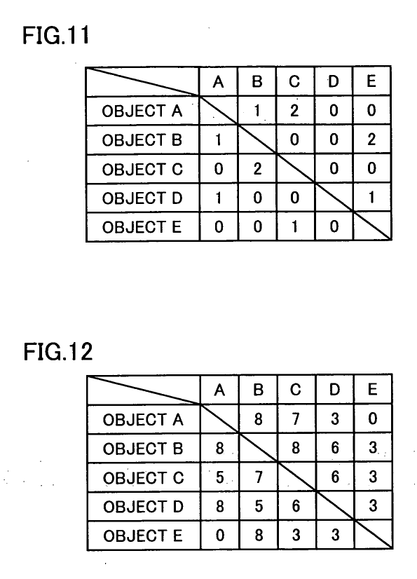

Evaluation values are found for an object sequence (A, B, A, C, B, D, E, C, B, D, A, C) in the foregoing manner according to Rules (1)-(5). The result is shown in the table in FIG. 12.

For example, attention is drawn to the fourth object C from the left of the object sequence above. When Rule (1) is applied to object C, the object selected two objects before object C is object B, and then an evaluation value (C, B) will be +1 point. Similarly, when Rule (2) is applied, the object selected one object before object C is object A, and then an evaluation value (C, A) will be +2 points. Similarly, when Rule (3) is applied, the object selected one object after object C is object B, and then an evaluation value (C, B) will be +3 points. Similarly, when Rule (4) is applied, the object two objects after object C is object D, and then an evaluation value (C, D) will be +2 points. Similarly, when Rule (5) is applied, the object selected three objects after object C is object E, and then an evaluation value (C, E) will be +1 point. Such calculation of evaluation values is performed on all the other objects, and the results obtained by adding up the points for each of the calculated evaluation values are recorded in the table of FIG. 12.

Referring to the table of FIG. 12, when object A is selected, the evaluation values (points) for the next selected objects are such that object B>object C>object D>object E. Thus, these objects are presented as object choices in order, thereby increasing the selection efficiency.

It is noted that the evaluation value may not be given according to Rules (1)-(5) but be given arbitrarily, and that an appropriate method of calculating an evaluation value varies depending on the kind of application. In the example of FIG. 12, the object selected recently and the object selected in the past are treated in the same way. However, an evaluation value may be calculated in such a manner that a recent selection history is given more importance by assigning a weight appropriately.

As previously mentioned in connection with the ordering according the selection tendency (possibility) with the table of FIG. 11, the table of FIG. 12 is maintained for each kind of operation so that the object choices can be presented in descending order of possibility of being a selected object according to the kind of operation, thereby resulting in an efficient object selecting process.

It is noted that the table of FIG. 12 is created by table creating unit 109 and stored in RAM 202. The content of this table is continuously updated by table creating unit 109.

The object selecting process including ordering using FIG. 11 or FIG. 12 is performed when the user presses “*” key of dial key 304.

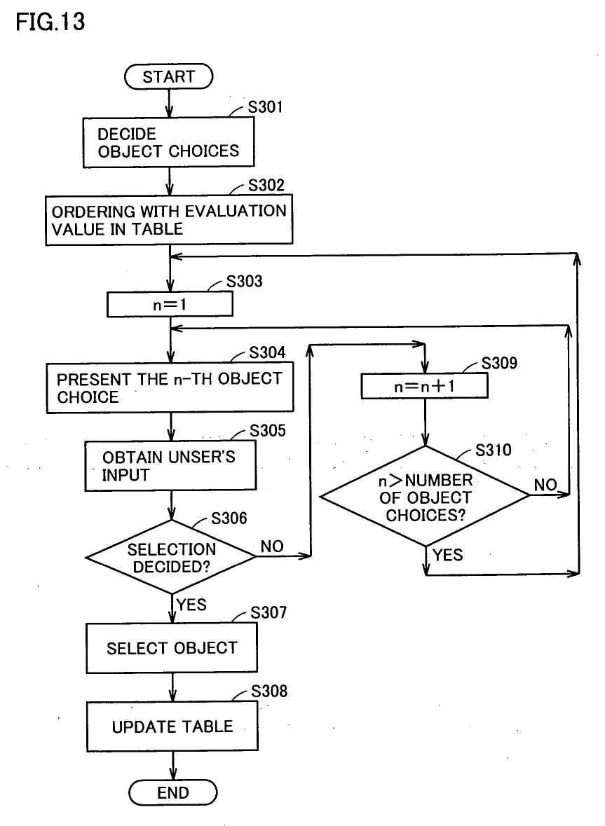

The flowchart of the object selecting process including ordering using FIG. 11 or FIG. 12 is shown in FIG. 13. Since the tendency (possibility) of selection shown in FIG. 11 can also be regarded as a kind of evaluation value for ordering, the two procedures as described above can be shown with the flowchart in FIG. 13. With reference to this flowchart, the procedure of object selection including ordering using the table will be described. It is noted that the table in FIG. 11 or FIG. 12 is assumed to be created beforehand by table creating unit 109.

In the flowchart of FIG. 13, when object choice deciding unit 102 decides a plurality of object choices in the similar manner as in S201 (S301), ordering unit 104 orders the object choices in descending order of evaluation value based on the content of the table of evaluation values in FIG. 11 or FIG. 12 that is created beforehand (S302). Thereafter, a control variable “n” is set to 1 (S303). Control variable “n” is used to count the ordinal position of the object choice presented with selection marks 401 by object choice presenting unit 107, that is, the ordinal position as arranged by the ordering.

Object choice presenting unit 107 presents the “n”-th object choice on screen 301 using selection mark 401 (S304). Thereafter, an input from the user is obtained from input unit 105 (S305). If the obtained input content is an input to indicate selection and decision caused by pressing key 303 (YES at S306), the “n”-th object choice as presented is selected by selecting unit 106 and then stored (S307). Thereafter, table creating unit 109 uses this selection result to update the content of the table of FIG. 11 or FIG. 12 in RAM 202 (S308).

If the obtained input content is not an input to indicate selection and decision (NO at S306), the value of control variable “n” is incremented by one (S309). As a result, if the value of control variable “n” exceeds the number of object choices, that is, if all the object choices are presented according to the ordering, the process returns to S303 to repeat the presentation from the first place again, and the following process is repeated similarly. If the value of control variable “n” does not exceed the number of object choices, the process returns to S304, and the following process is repeated similarly.

A selection method utilizing commonality of attribute information AT will now be described. In the method utilizing commonality of attribute information AT, object choices are divided into a plurality of groups based on the commonality of attribute information AT. When it is determined that the user successively selects object choices belonging to a certain group, the appearance of the object choice that belongs to that group but has not been selected is advanced, allowing the user to select an object promptly.

In a graphics editing application, the following Type (1)-Type (5) are assumed as the type of group as mentioned above.

Type (1): a group sorted by shapes based on object data DA, such as a character string, a rectangle, or a circle.

Type (2): a group sorted by colors based on color data D5.

Type (3): a group consisting of objects positioned on the same layer (overlapping layer) based on overlapping ordinal position data D7.

Type (4): a group consisting of objects displayed while being overlapped on another object based on overlapping ordinal position data D7.

Type (5): a group consisting of objects that have been selected by the user multiple times in the past based on creation date data D8, access date data D9, and update date data D10.

Since the group of Type (5), in particular, is a group of the object choice likely to be selected successively by the user, the method of ordering object choices belonging to this group is effective for the user to select a desired object promptly. Here, it is assumed that the user decides a plurality of selected objects in a single selection operation. A group falling into any of Type (1)-Type (5) as described above, for example, is created from a plurality of selected objects decided in the single selection operation.

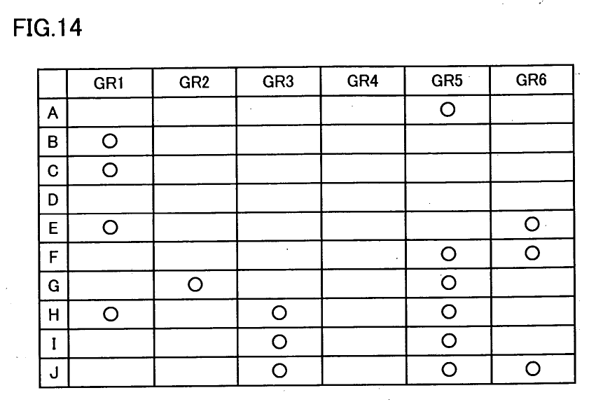

In the past, the user performed selection operations six times according to the flowchart in FIG. 2 or FIG. 13. For each time, a group consisting of a plurality of selected objects as decided is created. As a result, groups GR1-GR6 are assumed to be internally managed. Now, it is assumed that objects have been selected in order of A, B, C, D, E, F, G, H, I, J. It is assumed that these objects (selected objects) each belong to the groups with ο in the table of FIG. 14.

Referring to the table of FIG. 14, object J selected most recently belongs to groups GR3, GR5 and GR6. Recently, the objects belonging to group GR5 are selected consecutively five times, that is, objects E, F, G, H, and J belonging to group GR5 are successively selected in this order. Therefore, it can be understood that group GR5 is a group consisting of objects (object choices) that are likely to be successively selected by the user. Thus, ordering unit 104 performs ordering such that the object (object choice) that belongs to group GR5 and has not been selected at this time is presented by priority.

It is noted that, according to the table as shown in FIG. 14, it is necessary to set the following threshold values appropriately: a threshold value for the number of times of successive selections from a single group for deciding whether an object is presented by priority; and a threshold value for the number of objects that are selected in a single selection operation for deciding whether they are recognized as a group. The latter threshold value is specifically set with an upper limit and a lower limit. Here, the reason why the upper limit is set is as follows. If all the object choices on screen 301 are selected, it follows that the object choices belong to a corresponding group, which makes no sense as a criterion for the selection method, thereby decreasing accuracy of selection.

Furthermore, as the selection operations are repeated, the number of groups extremely increases, making the control difficult. In such a case, the groups are selected in order of LRU (Least Recently Used), starting from a group of which object has not recently been selected (group GR4 in the example of FIG. 14), and the selected group is replaced with another group thereby to limit the number of groups. The object that is selected next time by the user can be estimated quickly by limiting the number of groups.

The use of FIG. 14 as described above attains some degree of accuracy with respect to presenting an object that is most likely to be selected. However, an appropriate order may not be determined for the sequence of the following objects that are likely to be selected.

For this reason, it is reasonable that object choices are normally presented using the ordering based on a certain rule such as order of creation or order of distance as described above, and object choices are presented using the ordering with FIG. 14 by an interruption only when the system estimates the next object at or above a certain degree of accuracy. At that time, the user is informed, in a distinguishable manner with a sound or mark, that this presentation is a special one that is not according to the normal rule.

The object selecting process including the ordering using FIG. 14 is performed when the user presses “#” key of dial key 304.

### SECOND EMBODIMENT

The object selecting apparatus in FIG. 1 that implements the object selecting procedure as described above is implemented by a program. In this embodiment, this program is stored in a computer-readable recording medium.

In this embodiment, such a recording medium includes a program medium that may be a memory necessary for the process to be performed in the apparatus shown in FIG. 4, for example, ROM 203 itself, or a program medium that can be read by memory card access unit 208 functioning as a program reading device to which memory card 209 or an IC card as a recording medium is loaded.

Here, when a personal computer is adopted in place of a mobile phone, the aforementioned program medium is a recording medium that is detachable from the device itself It may be a tape-type medium such as a magnetic tape or a cassette tape, a disk-type medium such as a magnetic disk such as a flexible disk or a hard disk or an optical disk such as CD-ROM/MO (Magnetic Optical Disc)/MD (Mini Disc)/DVD (Digital Versatile Disc), a card-type medium such as an IC card (including a memory card)/an optical card, or a recording medium carrying a program in a fixed manner including a semiconductor memory such as a mask ROM, EPROM (Erasable and Programmable ROM), EEPROM (Electrically EPROM), or a flash ROM.

Furthermore, in the present embodiment, since the apparatus is configured to be connectable to communication network 210 including the Internet via communication unit 205, it may be a medium to which a program is downloaded from communication network 210, in other words, a recording medium carrying a program in flux.

It is noted that the content stored in the recording medium is not limited to a program and may be data.

The embodiments disclosed herein should be taken not by way of limitation but by way of illustration. The scope of the invention is shown not in the description above but in the claims, and it is intended that all the equivalents to the claims and modifications within the claims are embraced herein.

1. An object selecting apparatus comprising:
a presentation region;
an input unit externally operated;
ordering means ordering a plurality of object choices that are presented in said presentation region to be choices of selection, on a predetermined criterion that can arbitrarily be changed;
object choice presenting means presenting said plurality of object choices in a specific manner in said presentation region while switching on its own said plurality of object choices in order as arranged by said ordering means; and
selecting means selecting said object choice presented by said object choice presenting means as a desired object according to a predetermined input from said input unit.

2. The object selecting apparatus according to claim 1, wherein said object choice presenting means presents, for each switch input for switching from said input unit, said plurality of object choices in said specific manner while switching said plurality of object choices in order as arranged by said ordering means.

3. The object selecting apparatus according to claim 2, wherein said switch input is a same operation on said input unit for each time.

4. The object selecting apparatus according to claim 1, wherein said object choice presenting means presents, for each predetermined time period, said plurality of object choices in said specific manner while switching said plurality of object choices in order arranged by said ordering means.

5. The object selecting apparatus according to claim 1, wherein said predetermined criterion that can arbitrarily be changed is in accordance with choice attribute information indicative of an attribute, each of said plurality of object choices having an attribute of its own beforehand.

6. The object selecting apparatus according to claim 5, wherein said attribute information indicates a position of presentation of said object choice in said presentation region.

7. The object selecting apparatus according to claim 5, wherein said attribute information indicates an ordinal position of said object choice in an overlap of said plurality of object choices in said presentation region.

8. The object selecting apparatus according to claim 5, wherein said attribute information indicates a size of said object choice.

9. The object selecting apparatus according to claim 5, wherein said attribute information indicates an area of said object choice in said presentation region where said plurality of object choices are presented.

10. The object selecting apparatus according to claim 5, wherein when said object choice is selected as said desired object by said selecting means, a notification of said choice attribute information corresponding to the object choice is made.

11. The object selecting apparatus according to claim 1, wherein said predetermined criterion that can arbitrarily be changed is in accordance with a content of an external operation through said input unit.

12. The object selecting apparatus according to claim 1, wherein said predetermined criterion that can arbitrarily be changed is based on a history of selection of said desired object by said selecting means.

13. The object selecting apparatus according to claim 1, wherein said plurality of object choices are extracted from an object group that is presented beforehand in said presentation region based on input information through an external operation of said input unit.

14. The object selecting apparatus according to claim 13, wherein said input information indicates a kind of operation performed on said desired object.

15. The object selecting apparatus according to claim 13, further comprising notification means making a notification of object attribute information indicating an attribute possessed by an object in an object group presented in said presentation region beforehand, wherein
said input information indicates said object attribute information of which notification is made by said notification means.

16. The object selecting apparatus according to claim 1, wherein when said desired object selected most recently by said selecting means is included in said plurality of object choices, said ordering means orders said plurality of object choices excluding the desired object.

17. An object selecting method comprising:
a plurality of object choices that are presented in a presentation region prepared beforehand to be choices of selection, on a predetermined criterion that can arbitrarily be changed;
presenting said plurality of object choices in said presentation region in a specific manner while automatically switching said plurality of object choices in order as arranged at said ordering step; and
an object choice presented at said object choice presenting step as a desired object according to a predetermined input from an externally operated input unit prepared beforehand.

18. A machine-readable recording medium with an object selecting program recorded thereon for causing a computer to carry out an object selecting method,
said object selecting method including:
ordering a plurality of object choices that are presented in a presentation region prepared beforehand to be choices of selection, on a predetermined criterion that can arbitrarily be changed;
presenting said plurality of object choices in said presentation region in a specific manner while automatically switching said plurality of object choices in order as arranged at said ordering step; and
an object choice presented at said object choice presenting step as a desired object according to a predetermined input from an externally operated input unit prepared beforehand.

19. An object selecting program for causing a computer to carry out an object selecting method,
said object selecting method including:
ordering a plurality of object choices that are presented in a presentation region prepared beforehand to be choices of selection, on a predetermined criterion that can arbitrarily be changed;
presenting said plurality of object choices in said presentation region in a specific manner while automatically switching said plurality of object choices in order as arranged at said ordering step; and
an object choice presented at said object choice presenting step as a desired object according to a predetermined input from an externally operated input unit prepared beforehand.

20. A method of presenting a plurality of objects for selection comprising the steps of:
establishing an order for presenting individual ones of the plurality of objects for selection by a user based on one of a plurality of predetermined, arbitrarily changeable criteria; and
identifying, in the order, individual ones of the plurality of objects as being available for selection.

21. The method of claim 20 including the step of receiving a user input to select an identified individual one of the plurality objects.

22. The method of claim 20 wherein said step of identifying, in the order, individual ones of the plurality of objects as being available for selection comprises the step of automatically, sequentially identifying individual ones of the plurality of objects as being available for selection.

23. The method of claim 20 wherein said step of identifying, in the order, individual ones of the plurality of objects as being available for selection comprises the steps of identifying a first individual one, based on the order, of the plurality of objects as being available for selection and, upon receipt of a user input, identifying a second individual one, based on the order, of the plurality of objects as being available for selection.

24. The method of claim 20 including the additional step of associating a plurality of attributes with each of the plurality of objects, wherein said criteria are related to the attributes.
